(19) United States
(12) Patent Application Publication
(10) Pub. No.: US 2013/0097915 A1
(43) Pub. Date: Apr. 25, 2013

(54) FISHING JIG WITH MECHANISM FOR FISH HOOK REPLACEMENT

(71) Applicant: Michael Tamburro, Weston (CA)

(72) Inventor: Michael Tamburro, Weston (CA)

(21) Appl. No.: 13/276,958

(22) Filed: Oct. 19, 2011

(51) Int. Cl. A01K 85/00

(52) U.S. Cl. 43/43.16

(57) ABSTRACT

A fishing jig includes a wire that is at least partially embedded in the jig. The wire has a line tying section and a twist section. The line tying section is at one end portion of the wire. At least a portion of the line tying section, to which a fishing line is replaceably tied, protrudes from the jig. A twist section is at another end portion of the wire opposite to the one end portion with the line tying section. At least a portion of the twist section, to which a fish hook is replaceably attached, protrudes from the jig.

### FIELD OF THE INVENTION

The present invention relates to a jig used in fishing.

### BACKGROUND OF THE INVENTION

In the field of fishing equipment, companies such as Owner, Mustad, and Northland, are well known as manufacturers of conventional fishing jigs. In the conventional art, a fishing jig is configured to be permanently attached to a fish hook and molded as one-piece. Accordingly, the hook does not move freely and independently from the jig. Thus, the manufacturers need to provide a specific hook for a specific jig, and a fisherman cannot flexibly change hooks of his choice for the jig of his choice, depending on the style of how and what the fisherman chose to fish.

In addition, in such a configuration, once the hook becomes dull or damaged beyond repair, the jig must also be discarded. Further, because the hook does not move freely and independently from the jig, a fish can get leverage on the jig to throw and escape from the hook.

Therefore, in the conventional art, the above-discussed configuration of the jig cannot accommodate the creative nature of a fisherman to allow flexible arrangements. Also, such configuration does not allow the manufacturers to control costs and qualities of the jigs and the hooks independently and effectively.

### SUMMARY OF THE INVENTION

A fishing jig includes a wire that is at least partially embedded in the jig. The wire has a line tying section and a twist section for the angler's choice of hook. The line tying section is at one end portion of the wire. At least a portion of the line tying section, to which a fishing line is replaceably tied, protrudes from the jig. A twist section is at another end portion of the wire opposite to the one end portion with the line tying section. At least a portion of the twist section, to which a fish hook is replaceably attached, protrudes from the jig.

The fishing jig may have a wall on a surface of the jig, which surrounds the portion of the twist section of the wire protruding from the jig. Also, the fishing jig may have a shell that is at least partially embedded in the jig to create a cavity in the jig for at least a portion of the wire to be placed in the jig.

The twist section may have a wire end at the another end portion of the wire opposite to the one end portion with the line tying section. The twist section may also have a center portion between the line tying section and the wire end. The center portion of the twist section at least partially protrudes from the jig. A portion of the twist section between the center portion and the wire end is bent to go under the center portion of the twist section through a bottom side of the twist section and to have the wire end at a right side of the twist section.

### BRIEF DESCRIPTION OF THE DRAWINGS

A more complete appreciation of the invention and many of the intended advantages thereof will be readily obtained as the same becomes better understood by reference to the following detailed description when considered in connection with the accompanying drawings, wherein:

FIG. 1 is a perspective view that shows one embodiment of a fishing jig of the present invention with a fish hook attached and a plastic worm attached to the hook;

FIG. 2 is a perspective view of the jig of the present invention shown in FIG. 1;

FIG. 3 is another perspective view of the jig of the present invention, viewed from the rear side of the jig of the present invention shown in FIGS. 1 and 2;

FIG. 4 is a view of a twist section which the inventor coined as the Tamburro Twist of a wire of the jig shown in FIG. 3, viewed from the rear side of the twist section;

FIG. 5 is a view of the twist section of the wire of the jig shown in FIG. 4;

FIG. 6 is a view of the hook and the twist section of the wire of the jig shown in FIGS. 3-5:

FIG. 7 is a front view of another embodiment of a jig of the present invention;

FIG. 8 is a rear view of the another embodiment shown in FIG. 7;

FIG. 9 is a side view of the another embodiment shown in FIGS. 7 and 8;

FIG. 10 is a transparent side view of the jig shown in FIG. 9;

FIG. 11 is a front view of yet another embodiment of a jig of the present invention:

FIG. 12 is a rear view of the embodiment shown in FIG. 11;

FIG. 13 is a side view of the embodiment shown in FIGS. 11 and 12:

FIG. 14 is a transparent side view of the jig shown in FIG. 13;

FIG. 15 is a front view of yet another embodiment of a jig of the present invention;

FIG. 16 is a rear view the embodiment shown in FIG. 15;

FIG. 17 is a side view of the embodiment shown in FIGS. 15 and 16:

FIG. 18 is a transparent side view of the jig shown in FIG. 17;

### DETAILED DESCRIPTION OF THE INVENTION

The embodiments will now be described with reference to the accompanying drawings, wherein like reference numerals designate corresponding or identical elements throughout the various drawings. It is noted that the scope of the present invention is not limited to the embodiments shown in the accompanying drawings.

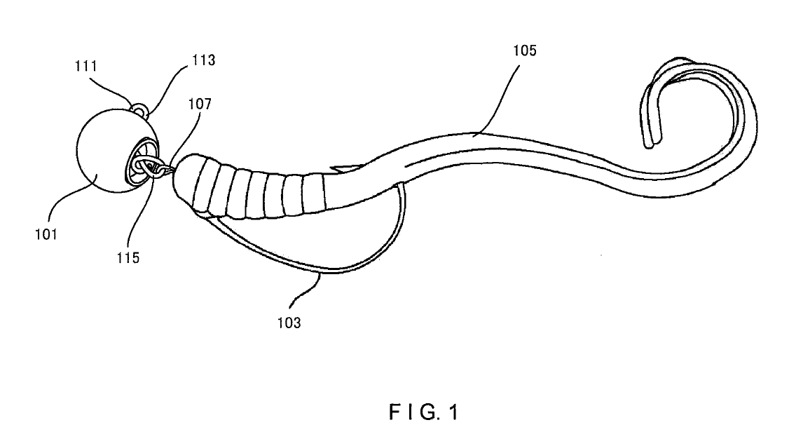

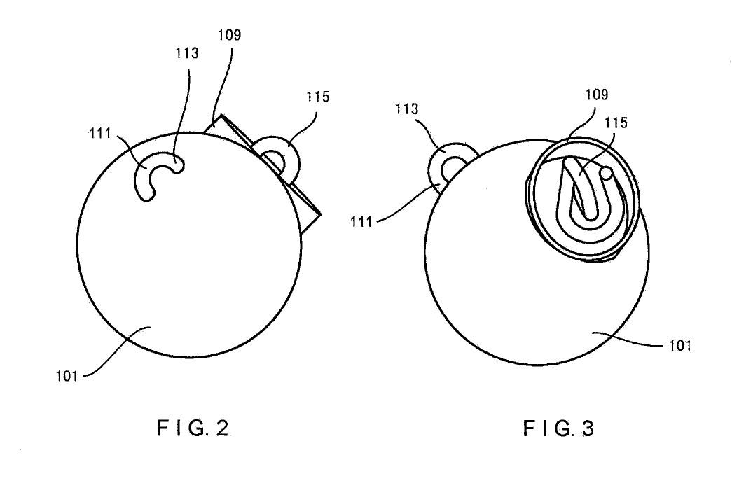

FIG. 1 is a perspective view that shows one non-limiting embodiment of a fishing jig 101 of the present invention. FIG. 2 is a perspective view of the jig 101. The jig 101 in this embodiment is, for example, a ball shaped jig. The jig 101 includes a wire 111 having a line tying section 113 at one end portion of the wire 111, and a twist section 115 at an other end portion of the wire 111. A fish hook 103 has an eyelet 107 that is replaceably attached to the twist section 115 of the wire 111. Also, a plastic worm 105 is attached to the hook 103.

The wire 111 of the jig 101 has a rating of 100 lbs.-1000 lbs and may be made of, for example, stainless steel. The wire 111 is at least partially embedded in the jig 101 with the line tying section 113 at least partially exposed in a front side of the jig 101 and the twist section 115 at least partially exposed in a rear side of the jig 101.

FIG. 3 is another perspective view of the jig 101 viewed from the rear side of the jig 101. The twist section 115 of the wire 111 protrudes from the jig 101 just below the center of a void and surrounded by a wall 109. The jig 101 may have a recessed portion in an area surrounded by the wall 109 to securely position the twist section on the jig 101. The wire 111 is at least partially embedded in the jig 101 to prevent the hook 103 from turning over on itself and getting fouled up.

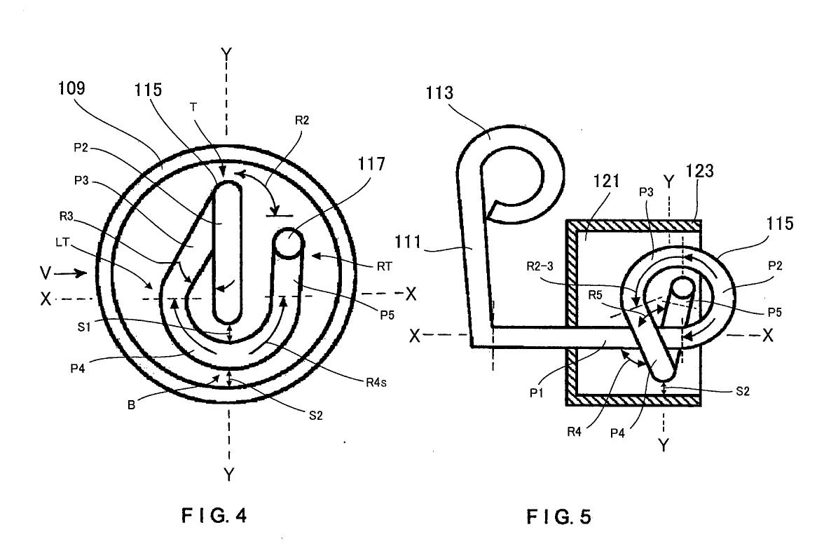

FIGS. 4 and 5 show how the twist section 115 of the wire 111 is configured to have a mechanism for fish hook replacement. The configuration of the twist section 115 is coined as the Tamburro Twist of a wire of the jig. FIG. 4 shows the rear side view of the twist section 115 in a substantially correct portional relation when the hook 103 is attached properly. FIG. 5 shows a left side view of the twist section 115 shown in FIG. 4 (i.e., viewed from a direction indicated by arrow V) in a substantially correct positional relation.

As shown in FIGS. 4 and 5, the twist section 115 of the wire III is a single wire, which is divided into five portions P1-P5 for the purpose of ease of explanation and illustration (i.e., The five portions P1-P5 are physically connected seamlessly as a single wire). The portion P1 of the twist section 115 is a center portion of the wire 111 which is closer to the line tying section 113 than other portions P2-P5 of the twist section 115. The portion 5 is the other end portion of the wire 111 opposite to the one end portion where the line tying section 113 is formed. The portion 5 has a wire end 117 at the end of the twist section 115. Also, the twist section has top side T, bottom side B, right side RT, and left side LT.

The portion P1 of the twist section 115 protrudes from a surface of the jig 101 at the rear side of the jig 101. Then, the portion P2 of the twist section 115 is bent into a half circle toward the top side T at an angle R2 in relation to horizontal plane X-X. In this non-limiting embodiment shown in FIGS. 4 and 5, the angle R2 is, for example, approximately 90 degrees along vertical axis Y-Y. Then, the portion P3 of the twist section 115 is bent away from vertical axis Y-Y toward the bottom side B at angle R3 in relation to vertical axis Y-Y. The angle R3 is preferably in a range between 25 degrees and 35 degrees. In this non-limiting embodiment shown in FIGS. 4 and 5, the angle R3 is, for example, approximately 30 degrees. As the portion P3 of the twist section 115 bends away at the angle R3, it is also bent so that the portion P4 extends toward the bottom side B at angle R4 in relation to horizontal plane X-X. The angle R4 is preferably in a range between 90 and 135 degrees. In this non-limiting embodiment shown in FIGS. 4 and 5, the angle R4 is, for example, approximately 112 degrees. Also, the combined portions of P2 and P3 makes a turn along vertical axis Y-Y, at angle R2-3. The angle R2-3 is preferably in a range between 235 degrees and 360 degrees.

In this non-limiting embodiment shown in FIGS. 4 and 5, the angle R2-3 is approximately 297 degrees.

The portion P4 of the twist section 115 is then bent at angle R4s going under the portion P1 of the twist section 115 through the bottom side B toward the right side RT. The angle R4s is preferably in a range between 145 degrees and 215 degrees. In this non-limiting embodiment shown in FIGS. 4 and 5, the angle R4s is, for example, approximately 180 degrees. A space S1 between the portion P1 and the portion P4 of the twist section 115 is such that a small snap is required when the eyelet 107 of the hook 103 passes around the twist section 115 through the space S1. The space S1 provides added security to the hook 103 from being thrown by a hooked fish.

Further, as shown in FIGS. 4 and 5, as the twist section 115 makes a return at the angle R4s, the wire end 117 of the twist section 115 finishes at angle R5 in relation to horizontal plane X-X, leaning slightly forward. The angle R5 is preferably in ranges between 80 degrees and 125 degrees. In this non-limiting embodiment shown in FIGS. 4 and 5, the angle R5 is, for example. approximately 102 degrees. As shown in FIG. 4, when the twist section 115 of the wire 111 is viewed from the rear of the jig 101, the wire end 117 is on the right side RT with the bend going under the wire to the left side LT.

As an alternative to the above-explained configuration of the twist section 115, the twist section may have a configuration with a mirror image of the above-explained configuration.

In this non-limiting embodiment shown in FIGS. 4 and 5, the wire III may be directly embedded in the jig 101. Alternatively, in order to, for example, ease the manufacturing process, a shell 121 may be embedded in the jig 101 to create a cavity in the jig 101 for a part of or all of the wire 111 to be placed in the cavity of the jig 101. The shell 121 may be made of, for example, metal such as tungsten, which can withstand heat from the molten led. The shell 121 may have a protruded shell wall 123 that replaces the wall 109 of the jig and protrudes from the surface of the jig 101.

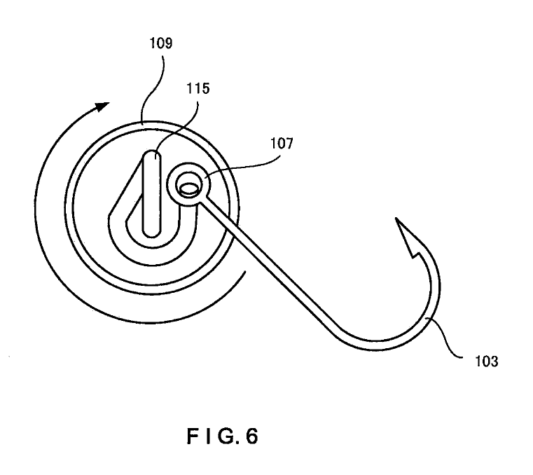

FIG. 6 shows how the hook 103 is installed to the twist section 115 of the wire 111 through the eyelet 107 of the hook 103. A clearance space S2 between the wire III and the wall 109 of the jig 101 must be tight enough for the eyelet 107 to just pass by. If the shell is used in the jig 101 and the protruded shell wall 123 replaces the wall 109, the clearance space S2 between the twist section 115 and the protruded shell wall 123 of the jig 101 must be tight enough for the eyelet 107 of the hook 103 to just pass by and the seta in place.

In this embodiment shown in FIGS. 1-6, the twist section 115 is configured in such a way for the fisherman to be able to put the eyelet 107 of the hook 103 on the wire end 117 of the twist section 115 with the hook 103 in a final desired orientation. Such a configuration enables the hook 103 to end up in the same orientation as the hook 103 was in when first entered into the twist section 115, since the hook 103 rotates 360 degrees as the eyelet 107 is lead through the twist section 115.

The twist section 115 may be used on jigs of most types and sizes. In addition, the line tying section 113 of the wire 111 is configured to give the wire 111 a sufficient strength, eliminating a possibility of a line tie to pull out when the fish is hooked or when the hook 103 and/or the jig 101 is caught on a rocky bottom.

Further, in this embodiment shown in FIGS. 1-6, because the jig 101 is configured as described above, the hook 103 moves independently to the jig 101, giving the fish a new action not seen before with plastic lures, or live or natural bait, on conventional one-piece rigid jig head and hook combos.

Moreover, because the jig 101 is configured as described above, it minimizes a possibility that the fish bends or stretches out the wire 111 and the twist section 115 of the wire 111 when the fish is hooked. The jig 101 is configured in such a way that the wire 111 and the twist section 115 of the wire 111 tighten on the hook 103 instead of letting go or stretching out.

In the present invention, the jig 101 allows the fisherman to have this jig 101 as a universal and standard jig in most tackle boxes. A manufacturer of the jig 101 does not need to provide the hook 103 and the fisherman can change the style of how he fishes, with a different style of hook. Now this jig 101 provides the fisherman with flexibility to respond to the creative nature of the fisherman, the water and/or weather conditions, and species he seeks.

Also, from a manufacturing stand point, costs of manufacturing a quality hook affect to actual costs of manufacturing a fishing lure when the hook is permanently integrated in the fishing lure together with a jig. With the jig 101 of the present invention, the fisherman can just replace the hook 103 and he can be back fishing while saving time and money.

Accordingly, the jig 101 of the present invention gives the fisherman a quality jig with the mechanism that can be used with any hook he desires and provides.

The mechanism for flexible fish hook replacement described above on the jig 101, which is a ball or round jig, may be applied on different types of jigs, such as a simple ball jig, a football jig, a swim head jig, a weed less jig, and a flipping jig.

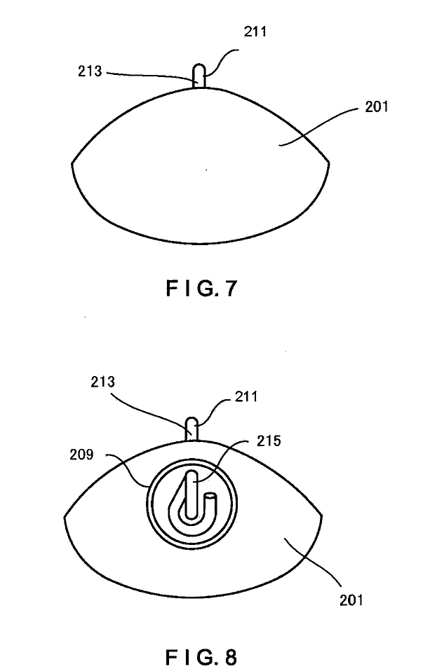

FIGS. 7-10 show another embodiment of the present invention, which is a football shaped jig 201. FIG. 7 is a front view of the football shaped jig 201. FIG. 8 is a rear view of the football shaped jig 201. The football shaped jig 201 has a wire 211 having a line tying section 213 at one end portion of the wire 211, and a twist section 215 at an other end portion of the wire 211. The football shaped jig 201 has a wall 209 that surrounds the twist section 215.

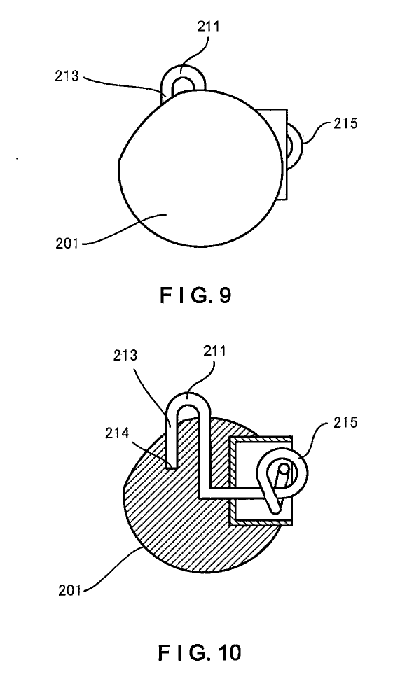

FIG. 9 is a side view of the football shaped jig 201, showing the line tying section 213 at least partially exposed from a front side of the football shaped jig 201, and the twist section 215 of the wire 211 at least partially exposed from a rear side of the football shaped jig 201. FIG. 10 is a transparent side view of the football shaped jig 201. FIG. 10 shows how the wire 211 is configured for the football shaped jig 201. The line tying section 213 is bent into a “U” shape with a wire end 214 embedded within the football shaped jig 201. The wire 211 may be made of, for example, stainless steel.

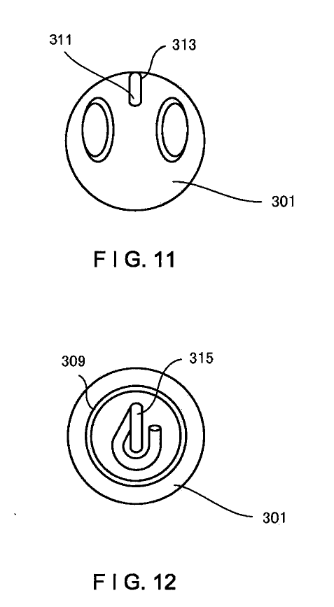

FIGS. 11-14 show another embodiment of the present invention, which is a swim jig 301. FIG. 11 is a front view of the swim jig 301. FIG. 12 is a rear view of the swim jig 301. The swim jig 301 has a wire 311 having a line tying section 313 at one end portion of the wire 311, and a twist section 315 at an other end portion of the wire 311. The swim jig 301 has a wall 309 that surrounds the twist section 315.

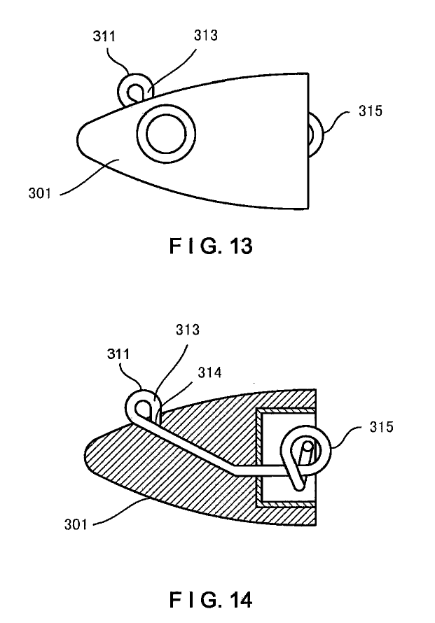

FIG. 13 is a side view of the swim jig 301, showing the line tying section 313 at least partially exposed from a front side of the swim jig 301, and the twist section 315 of the wire 311 at least partially exposed from a rear side of the swim jig 301.

FIG. 14 is a transparent side view of the swim jig 301. FIG. 14 shows how the wire 311 is configured for the swim jig 301. The line tying section 313 is bent into a mini-circle shape with a wire end 314 embedded within the swim jig 301. The wire 311 may be made of, for example, stainless steel.

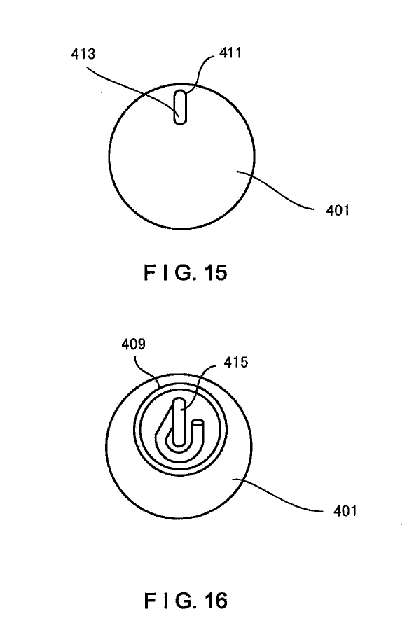

FIGS. 15-18 show another embodiment of the present invention, a weed less jig 401. FIG. 15 is a front view of the weed less jig 401. FIG. 16 is a rear view of the weed less jig 401. The weed less jig 401 has a wire 411 having a line tying section 413 at one end portion of the wire 411, and a twist section 415 at an other end portion of the wire 411. The weed less jig 401 has a wall 409 that surrounds the twist section 415.

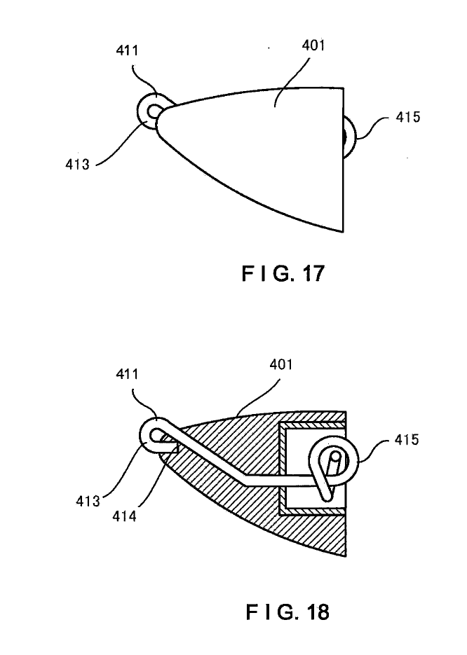

FIG. 17 is a side view of the weed less jig 401, showing the line tying section 413 at least partially exposed from a front side of the weed less jig 401, and the twist section 415 of the wire 411 at least partially exposed from a rear side of the weed less jig 401.

FIG. 18 is a transparent side view of the weed less jig 401. FIG. 18 shows how the wire 411 is configured for the weed less jig 401. The line tying section 413 is bent into a mini-tear drop shape with a wire end 314 embedded within the weed less jig 413. The wire 411 may be made of, for example, stainless steel.

Obviously, numerous modifications and variations of the present invention are possible in light of the above teachings. It is therefore to be understood that within the scope of the appended claims, the invention may be practiced otherwise than as specifically described herein.

1. A fishing jig comprising:
a wire that is at least partially embedded in the jig, the wire having
a line tying section at one end portion of the wire, at least a portion of which protruding from the jig, and to which a fishing line is replaceably tied, and
a twist section at another end portion of the wire opposite to the one end portion with the line tying section, at least a portion of which protruding from the jig, and to which a hook is replaceably attached.

2. The fishing jig according to claim 1, further comprising:
a wall on a surface of the jig, which surrounds the portion of the twist section of the wire, which protrudes from the jig.

3. The fishing jig according to claim 1, further comprising:
a shell configured to be at least partially embedded in the jig to create a cavity in the jig for at least a portion of the wire to be placed in the jig.

4. The fishing jig according to claim 1, wherein
the twist section has
a wire end at the another end portion of the wire opposite to the one end portion with the line tying section, and
a center portion between the line tying section and the wire end,
the center portion of the twist section at least partially protrudes from the jig, and
a portion of the twist section between the center portion and the wire end is bent to go under the center portion of the twist section through a bottom side of the twist section and to have the wire end at a right side of the twist section.

5. The fishing jig according to claim 4, wherein, before the portion of the twist section between the center portion and the wire end is bent to go under the center portion of the twist section,
the portion is bent into a half circle at a predetermined angle in relation to a horizontal plane, and
the portion is continued being bent away from a vertical axis of the twist section at a predetermined angle in relation to the vertical axis Y-Y and also bent to have the portion extend at a predetermined angle in relation to the horizontal plane.
